(19) United States
(12) Patent Application Publication
(10) Pub. No.: US 2010/0215052 A1
(43) Pub. Date: Aug. 26, 2010

(54) ISCSI NETWORK INTERFACE CARD WITH ARP/ICMP RESOLUTION FUNCTION

(75) Inventors: Wei LIU, Tianjin (CN); Yun-Song WANG, Tianjin (CN); Tom CHEN, Taipei (TW)

Correspondence Address: RABIN & Berdo, PC, 1101 14TH STREET, NW, SUITE 500, WASHINGTON, DC, 20005, US

(73) Assignee: INVENTEC CORPORATION, Taipei (TW)

(21) Appl. No.: 12/389,511

(22) Filed: Feb. 20, 2009

(51) Int. Cl. H04L 12/66

(52) U.S. Cl. 370/463

(57) ABSTRACT

An iSCSI network interface card with an ARP/ICMP resolution function is applicable to provide a communication interface between a host and a client, and includes a first connection interface, an ARP procedure, an ICMP procedure, a storage unit, and a processor. The first connection interface is connected to the host. The ARP procedure queries an IP address of the client. The ICMP procedure transfers a message of failing to reach the IP address of the client and detects a connecting status to the Internet. The storage unit is connected to the first connection interface and stores the network packet, the ARP procedure, and the ICMP procedure. The processor is connected to the first connection interface and the storage unit, and executes the ARP procedure and the ICMP procedure according to a service request.

### BACKGROUND OF THE INVENTION

1. Field of the Invention

The present invention relates to an iSCSI network interface card, and more particularly to an iSCSI network interface card with an ARP/ICMP resolution function.

2. Related Art

With the rapid development and popularization of the network technology, the Internet has played an indispensable role in people's daily life, so that people exchange the needed information over Internet rapidly. A network interface card (NIC) functions to enable computers to interconnect with each other, so as to share resources and exchange information. The Internet Engineering Task Force (IETF) has proposed a communication protocol standard of the internet small computer systems interface (iSCSI), which is used to link a plurality of computers together through a transmission control protocol/Internet protocol (TCP/IP) communication protocol to form a virtual network storage server. The virtual network storage server is capable of transmitting data in a high speed and expanding/backing up the capacity of virtual storage devices unlimitedly.

FIG. 1 is a schematic view of an architecture of an iSCSI network interface card and a host in the prior art. Referring to FIG. 1, the architecture 100 of the iSCSI network interface card and the host includes a host 110, a host bus adapter driver 112, an address resolution protocol (ARP)/Internet control message protocol (ICMP) 114, an iSCSI network interface card 120, an iSCSI protocol 122, a network layer 124, and a peripheral component interconnect express (PCI-E) 130. The iSCSI network interface card 120 is connected to the host 110 via the PCI-E 130.

Computers communicate with each other by packets. During transmission, after being processed by the ARP/ICMP 114, the packets are transferred by the iSCSI network interface card 120. The ARP/ICMP 114 is executed by the host bus adapter driver 112 of the host 110. When it intends to transmit a large number of packets, the workload of the host 110 is increased, and the execution speed thereof is reduced.

### SUMMARY OF THE INVENTION

In view of the above problems, the present invention is directed to an iSCSI network interface card with an ARP/ICMP resolution function, so as to realize an ARP procedure and an ICMP procedure in the network interface card.

Therefore, the present invention provides an iSCSI network interface card with an ARP/ICMP resolution function, which includes a first connection interface, an ARP procedure, an ICMP procedure, a storage unit, and a processor. The first connection interface is electrically connected to the host. The ARP procedure is used to query an IP address of a client. The ICMP procedure is used to process a circumstance that the IP address of the client cannot be reached and detect a connecting status to the Internet. The storage unit is electrically connected to the first connection interface and is used to store the network packet, the ARP procedure, and the ICMP procedure. The processor is electrically connected to the first connection interface and the storage unit. The processor executes the ARP procedure and the ICMP procedure according to a service request.

The present invention provides an iSCSI network interface card with an ARP/ICMP resolution function, and the iSCSI network interface card is combined with an ARP procedure and an ICMP procedure. The iSCSI network interface card with the ARP/ICMP resolution function can reduce the workload of the host driver, thereby increasing the operation efficiency of the iSCSI.

### BRIEF DESCRIPTION OF THE DRAWINGS

The present invention will become more fully understood from the detailed description given herein below for illustration only, which thus is not limitative of the present invention, and wherein:

FIG. 1 is a schematic view of an architecture of an iSCSI network interface card and a host in the prior art.

FIG. 2 is a schematic view of an architecture of a system according to the present invention.

FIG. 3 is a schematic view of an architecture of an iSCSI network interface card with an ARP/ICMP resolution function according to an embodiment of the present invention.

FIG. 4 is a flow chart of querying an IP address of a client in an ARP procedure according to an embodiment of the present invention.

FIG. 5 is a flow chart of performing conflict detection on the IP address in the ARP procedure according to an embodiment of the present invention.

FIG. 6 is a flow chart of processing the circumstance that a network packet cannot be sent to the client in an ICMP procedure according to an embodiment of the present invention.

FIG. 7 is a flow chart of detecting a connecting status to the Internet in the ICMP procedure according to an embodiment of the present invention.

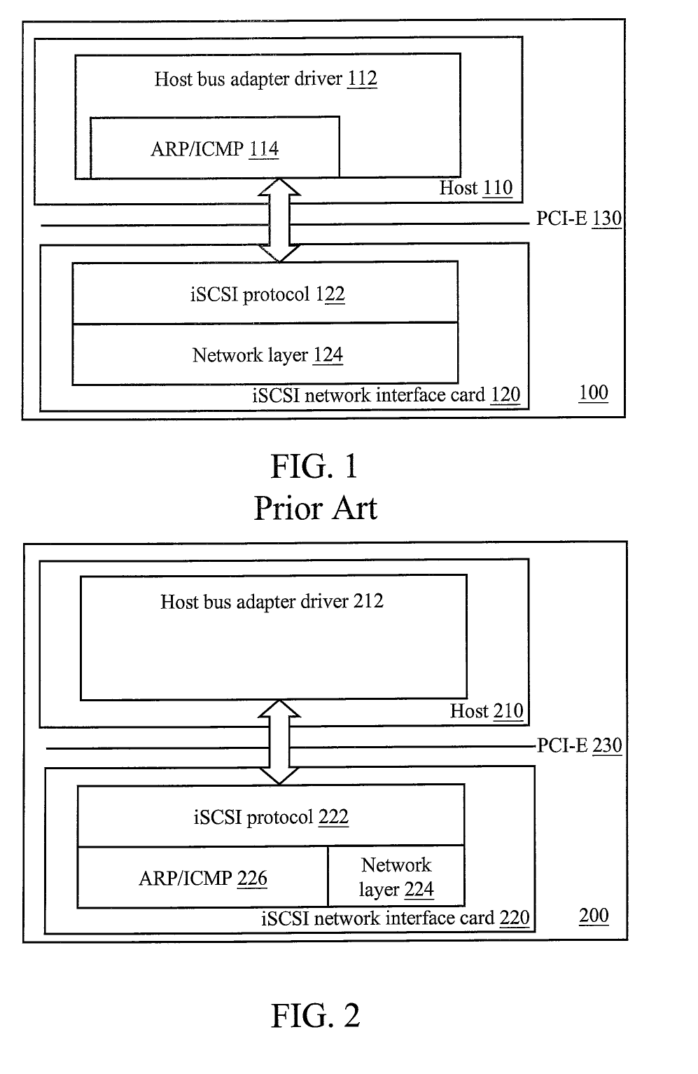

### DETAILED DESCRIPTION OF THE INVENTION

FIG. 2 is a schematic view of an architecture of a system according to the present invention. Referring to FIG. 2, the architecture 200 of the iSCSI network interface card and the host includes a host 210, a host bus adapter driver 212, an iSCSI network interface card 220, an iSCSI protocol 222, a network layer 224, an ARP/ICMP 226, and a PCI-E 230. The iSCSI network interface card 220 is connected to the host 210 via the PCI-E 230.

Computers communicate with each other by packets. During the packet transmission, after being processed by the ARP/ICMP 226, the packets are transferred by the iSCSI network interface card 220. The ARP/ICMP 226 is executed in the iSCSI network interface card 220.

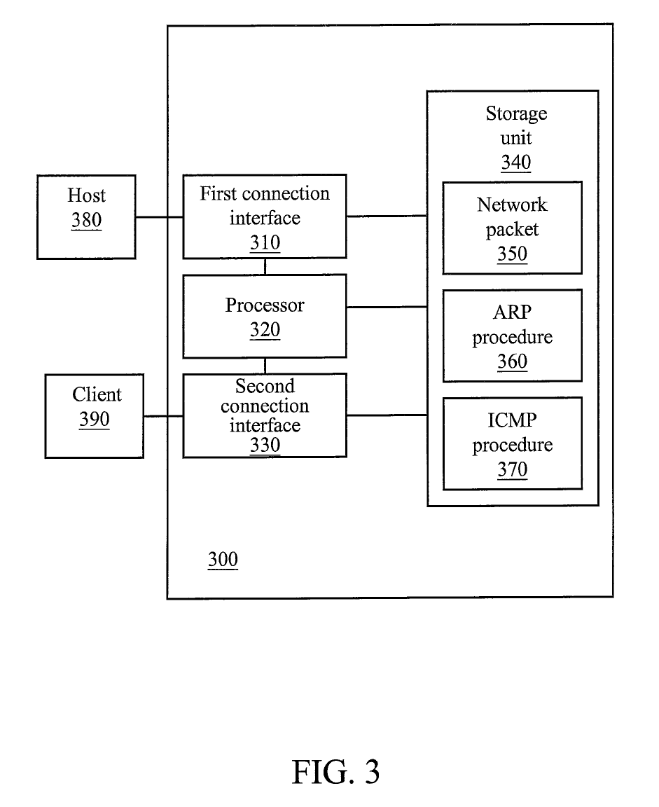

FIG. 3 is a schematic view of an architecture of an iSCSI network interface card with an ARP/ICMP resolution function according to an embodiment of the present invention.

The network interface card of the present invention can be disposed in a computer device, or in other network devices. Referring to FIG. 3, a network interface card 300 includes a first connection interface 310, a processor 320, a second connection interface 330, a storage unit 340, a network packet 350, an ARP procedure 360, and an ICMP procedure 370.

The first connection interface 310 is electrically connected to the host 380. The first connection interface 310 can be a peripheral component interconnect (PCI) interface, a universal serial bus (USB) interface, or a personal computer memory card international association (PCMCIA) interface. The second connection interface 330 is electrically connected to the processor 320 and the storage unit 340. The second connection interface 330 is connected to the client 390 through the Internet. The second connection interface 330 can be a PCI interface, a USB interface, or a PCMCIA interface.

The storage unit 340 is electrically connected to the first connection interface 310 and is used to store the network packet 350, the ARP procedure 360, and the ICMP procedure 370. The processor 320 is electrically connected to the first connection interface 310 and the storage unit 340. The processor 320 executes the ARP procedure 360 and the ICMP procedure 370 according to a service request from the host 380. The ARP procedure 360 is used to query an IP address of the client 390 or perform conflict detection on the IP address. The ICMP procedure 370 is used to transfer a message of failing to reach the IP address of the client 390, detect a connecting status to the Internet, and send the detected connecting status to the host 380.

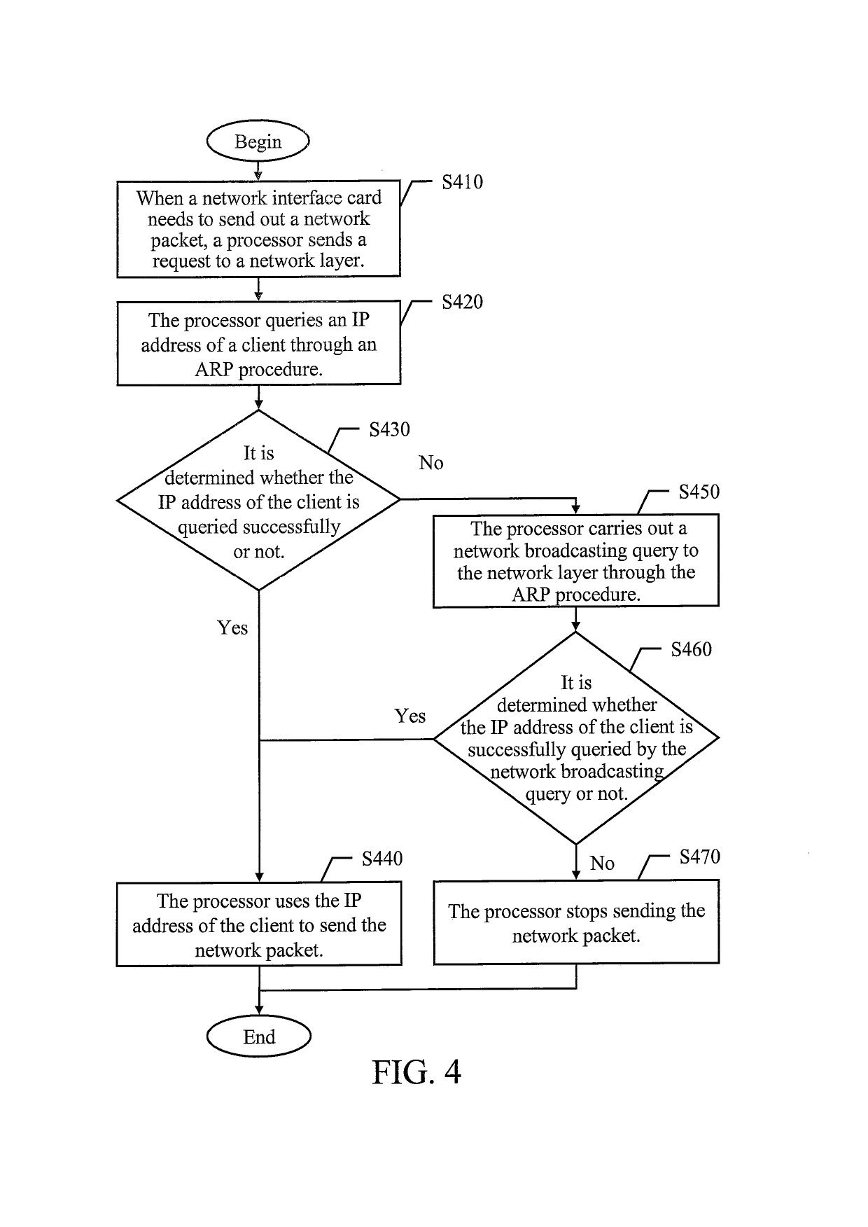

FIG. 4 is a flow chart of querying an IP address of a client in an ARP procedure according to an embodiment of the present invention. Referring to FIG. 4, the flow of the present invention includes the following steps. When a network interface card needs to send out a network packet, a processor sends a request to a network layer (Step S410). The processor queries an IP address of a client through an ARP procedure (Step S420). It is determined whether the IP address of the client is queried successfully or not (Step S430). If the query is successful, the processor uses the IP address of the client to send the network packet (Step S440).

If the query fails, the processor carries out a network broadcasting query to the network layer through the ARP procedure (Step S450). The network broadcasting query is used to query the IP address of the client. It is determined whether the IP address of the client is successfully queried by the network broadcasting query or not (Step S460). If the query is successful, the processor uses the IP address of the client to send the network packet (Step S440). If the query fails, the processor stops sending the network packet (Step S470).

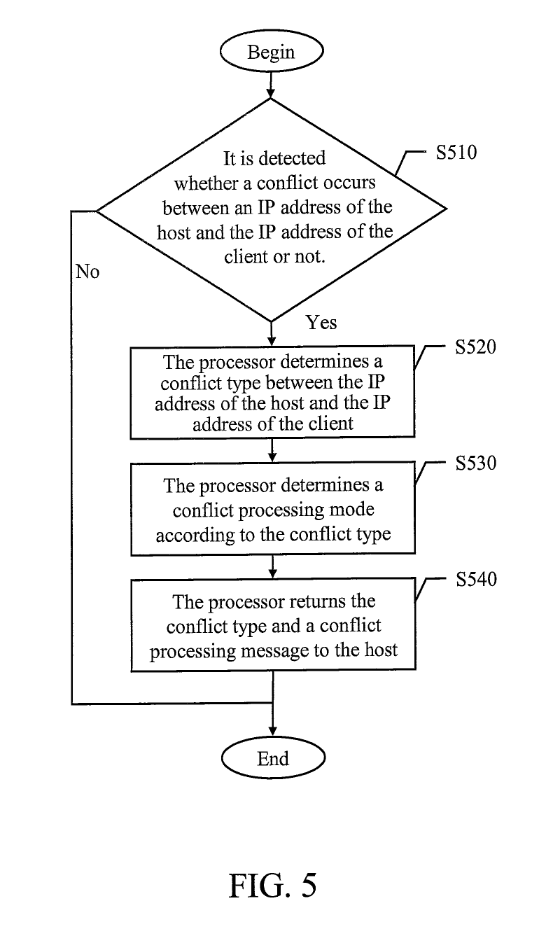

FIG. 5 is a flow chart of performing conflict detection on the IP address in the ARP procedure according to an embodiment of the present invention. Referring to FIG. 5, the flow of the present invention includes the following steps. It is detected whether a conflict occurs between an IP address of the host and the IP address of the client or not (Step S510). If the conflict occurs, the processor determines a conflict type between the IP address of the host and the IP address of the client (Step S520). The conflict type includes an active conflict and a passive conflict. Then, the processor determines a conflict processing mode according to the conflict type (Step S530). Finally, the processor returns the conflict type and a conflict processing message to the host (Step S540).

The active conflict means that the processor has detected that a newly-set IP address of the client is the same as the IP address of the host. The passive conflict means that the processor has received a conflict notification from the client, and the conflict notification notifies that a newly-set IP address of the host is the same as the IP address of the client. In addition, the conflict processing can include disabling the network interface card, or obtaining a valid IP address again and returning the valid IP address to the host.

In addition to executing the ARP procedure as described above, the processor further executes the ICMP procedure.

The processor executes the ICMP procedure according to a service request from the host, which can be used to transfer a message of failing to reach the IP address of the client and detect a connecting status to the Internet.

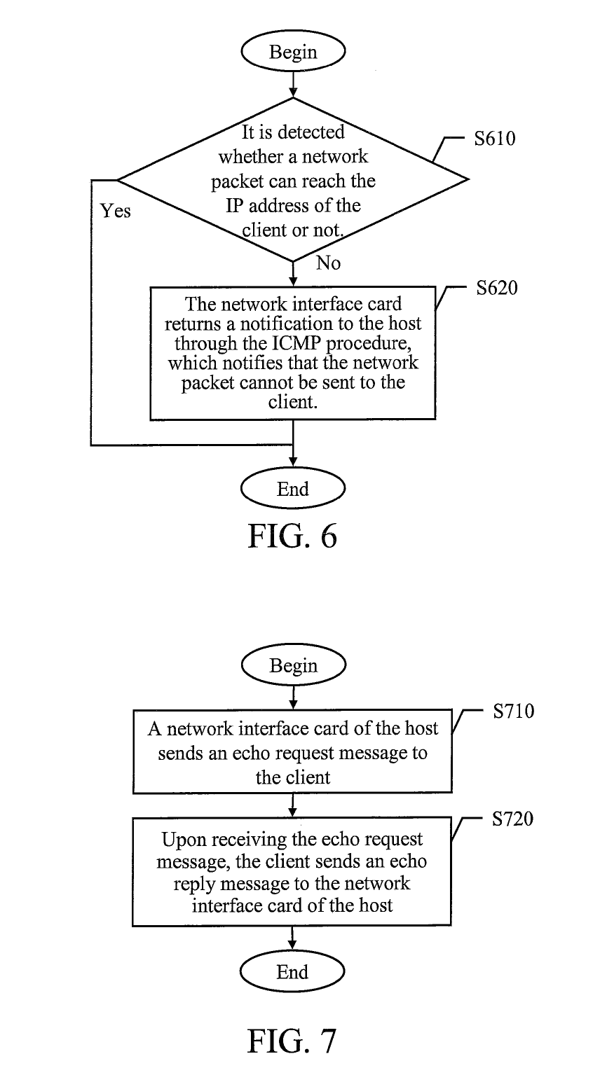

FIG. 6 is a flow chart of processing the circumstance that a network packet cannot be sent to the client in an ICMP procedure according to an embodiment of the present invention. Referring to FIG. 6, the flow of the present invention includes the following steps. It is detected whether a network packet can reach the IP address of the client or not (Step S610); and if not, the network interface card returns a notification to the host through the ICMP procedure, which notifies that the network packet cannot be sent to the client (Step S620).

FIG. 7 is a flow chart of detecting a connecting status to the Internet in the ICMP procedure according to an embodiment of the present invention. Referring to FIG. 7, the flow of the present invention includes the following steps. A network interface card of the host sends an echo request message to the client (Step S710). Upon receiving the echo request message, the client sends an echo reply message to the network interface card of the host (Step S720). The combination of the echo request message and the echo reply message is used to detect the connecting status to the Internet.

The present invention provides an iSCSI network interface card with an ARP/ICMP resolution function, and the iSCSI network interface card is combined with an ARP procedure and an ICMP procedure. The iSCSI network interface card with the ARP/ICMP resolution function can reduce the workload of the host driver, thereby enhancing the operation efficiency of the iSCSI systems.

What is claimed is:

1. An iSCSI network interface card with an ARP/ICMP resolution function, applicable to provide a communication interface between a host and a client, the iSCSI network interface card comprising:
a first connection interface, electrically connected to the host;
an address resolution protocol (ARP) procedure, used to query an IP address of the client;
an Internet control message protocol (ICMP) procedure, used to transfer a message of failing to reach the IP address of the client and detect a connecting status to the Internet;
a storage unit, electrically connected to the first connection interface, and used to store a network packet, the ARP procedure, and the ICMP procedure; and
a processor, electrically connected to the first connection interface and the storage unit, and used to execute the ARP procedure and the ICMP procedure according to a service request.

2. The iSCSI network interface card with an ARP/ICMP resolution function according to claim 1, wherein the iSCSI network interface card further comprises:
a second connection interface, electrically connected to the processor and the storage unit, and connected to the client through the Internet.

3. The iSCSI network interface card with an ARP/ICMP resolution function according to claim 1, wherein the ARP procedure further comprises:
if the query of the IP address of the client is successful, transferring the network packet by the processor according to the IP address of the client;
if the query of the IP address of the client fails, sending a broadcast packet by the processor, wherein the broadcast packet is used to query the IP address of the client; and
transferring the network packet according to a query result of the broadcast packet.

4. The iSCSI network interface card with an ARP/ICMP resolution function according to claim 1, wherein the ARP procedure further comprises:
if a conflict occurs between an IP address of the host and the IP address of the client, executing the following operations by the processor:
determining a conflict type between the IP address of the host and the IP address of the client;
executing a conflict processing procedure according to the conflict type; and
returning the conflict type and a processing result of the conflict processing procedure to the host.

5. The iSCSI network interface card with an ARP/ICMP resolution function according to claim 4, wherein the conflict type comprises:
an active conflict, wherein the active conflict means that the processor has detected that a newly-set IP address of the client is the same as the IP address of the host; and
a passive conflict, wherein the passive conflict means that the processor has received a conflict notification from the client, and the conflict notification notifies that a newly-set IP address of the host is the same as the IP address of the client.

6. The iSCSI network interface card with an ARP/ICMP resolution function according to claim 4, wherein the conflict processing procedure comprises:
disabling the network interface card; and
obtaining a valid IP address again and returning the valid IP address to the host.

7. The iSCSI network interface card with an ARP/ICMP resolution function according to claim 1, wherein the ICMP procedure further comprises:
if the IP address of the client cannot be reached, sending a message of failing to reach the IP address of the client to the network interface card by the ICMP procedure.

8. The iSCSI network interface card with an ARP/ICMP resolution function according to claim 1, wherein the ICMP procedure further comprises:
returning the connecting status of the client to the Internet to the network interface card.
